(19) United States
(12) Patent Application Publication
(10) Pub. No.: US 2022/0007681 A1
(43) Pub. Date: Jan. 13, 2022

(54) Method for Producing Extruded Puffed Protein

(71) Applicant: Glanbia Nutritionals Ltd., Kilkenny (IE)

(72) Inventors: Mark A. Stout, Twin Falls, ID (US); Brent L. Petersen, Twin Falls, ID (US)

(73) Assignee: Glanbia Nutritionals Ltd., Kilkenny (IE)

(21) Appl. No.: 17/373,719

(22) Filed: Jul. 12, 2021

Related U.S. Application Data
(60) Provisional application No. 63/050,856, filed on Jul. 12, 2020.

(51) Int. Cl. A23J 3/26; A23J 3/08; A23J 3/14; A23P 10/22; A23L 33/19; A23L 33/185

(52) U.S. Cl. CPC A23J 3/26; A23J 3/08; A23J 3/14; A23V 2002/00; A23L 33/19; A23L 33/185; A23P 10/22

(57) ABSTRACT

Disclosed is a method for extruding protein, such as whey protein, for example, in a puffed form that can readily be ground, milled, or otherwise reduced in size to produce protein powder that can be used to reduce hardening in protein bars. The method uses acidification of the protein to modify its behavior during the extrusion process and produce extruded products (e.g., crisps) with improved properties.

### FIELD OF THE INVENTION

The invention relates to methods for making protein products using extrusion technology. More specifically, the invention relates to methods for extruding protein to form puffed protein, which can, optionally, then be used to produce protein powder with added functionality.

### BACKGROUND OF THE INVENTION

High protein bars are usually made of about 30 percent fat, 30 percent protein powder, and 40 percent sugar syrup, along with minor components that may include flavorings, stabilizers, and inclusions such as peanuts and fruit. The protein source is usually selected from either whey protein isolate (WPI), whey protein concentrate (WPC), or a protein blend containing hydrolyzed whey protein. WPI generally contains at least 90% protein, while WPC generally contains from about 34 percent to about 80 percent protein. The fat source used most often is either vegetable shortening, cocoa butter or some type of oil (e.g., canola or vegetable). The carbohydrate source is usually a blend of high fructose corn syrup (HFCS) and a sugar alcohol (sorbitol or maltitol) syrup, which is usually the only source of water in the bar formulation, the syrup (comprising about 70 to 80% solids) binding all the ingredients in the bar together.

Initially, this ingredient combination produces dough that is soft, malleable, and easily formed into bars. However, the onset of hardening in high-protein nutritional bars begins fairly soon after they are made. Immediately after manufacture, most nutritional bars have a soft nougat-like texture, but after a one-month storage at room temperature the bars will harden to some degree—and after four to six months the bars will generally become hard enough to make them difficult to chew. Generally, the higher the protein level in high-protein nutritional bars, the faster they harden to an unacceptable degree. McMahon et al. reported that in bars made with whey protein isolate (WPI) phase separation occurred between the protein and carbohydrate, and proposed that this phase separation is what initiates bar hardening and promotes subsequent protein aggregation. (McMahon, D. J. et al., Hardening of High-Protein Nutrition Bars and sugar/polyol-protein Phase Separation, J Food Sci (2009) Aug;74(6): E312-21.) Later observations led to the observation that hardening of HPN bars is a result of interactions between the cosolvents and the protein surface, rather than phase separation. (McMahon, D. J. et al., Hardening and microstructure of high protein nutrition bars made using whey protein isolate or milk protein concentrate, 2016 Joint Annual Conference—American Dairy Science Association, Salt Lake City, Utah.)

Various optional ingredients, processing steps, etc., have been utilized in an effort to minimize bar hardening. Much of the work has focused on the protein ingredients. For example, some formulators use hydrolyzed proteins almost exclusively. However, hydrolyzed proteins generally cost more than WPI or WPC, and their use can create quality issues such as bitter off-flavors and negative textural changes. Furthermore, the benefit of using hydrolyzed protein in bars can also be lost if the ingredients are overmixed and the proteins tend to lose their softening effect. Bars containing hydrolyzed protein also tend to stick to equipment, making them harder to process.

Extrusion processing provides a way to modify the properties of proteins. Extrusion texturization is a process that uses mechanical shear, heat, and pressure generated in the food extruder to change the structures of food components, including proteins. Such extrusion processing generally involves transferring protein into a twin-screw extruder, which contains two internal rotating screws that press material against heated barrel walls, forcing the resulting molten mass through a die which aligns the mass in the direction of rotational flow. Extrusion has been used to produce meat-like textures from plant proteins on one hand, and on the other it has also been used to produce protein “crisps” from combinations of protein and carbohydrates (e.g., starch)—the carbohydrate aiding in the formation of the desired light, crisp textures, because high-protein mixes tend to form tough, textured extruded products rather than light, crisp textures.

Proteins that have hydrophobic regions exposed on their surface will tend to aggregate together. EI-Ghany et al. reported that in whey protein concentrate and whey protein isolate, denaturation increases accessibility to the proteins' polar amino-acid groups, and enhances their affinity for water. e (El-Ghany, I. H. A. et al. Effect of Milk Proteins on Physical and Chemical Characteristics of Crispy Puff Snacks, Journal of Agricultural Science and Technology A 3 (2013) 633-645). Processing whey protein to produce sufficient denaturation to reduce protein aggregation could therefore provide one option for decreasing bar hardening.

Banach et al. disclosed that when milk protein concentrate (MPC—20% whey protein, 80% casein protein) is extruded and milled, it can be used to produce high-protein nutrition bars that harden slower than those formulated with toasted or unmodified MPC. Extruded MPC80 also had reduced free sulfhydryl group exposure, high-protein nutrition bars formulated with extruded MPC80 were less prone to phase separations, micronutrient phase separation being known to be associated to some degree with textural changes in nutritional bars. (Banach, J. C., Clark, S., and Lamsal, B. P., Microstructural Changes in Model High-protein Nutrition Bars Formulated with Modified Milk Protein Concentrates, Journal of Food Science, (2016) 81(2): C332-C340.)

However, the primary proteins in MPC are caseins, while extrusion of isolated whey protein (e.g., WPI, WPCs) can be complicated by the protein sticking to the components of the extruder, clogging the extruder, etc. This can cause “surging,” which is a variation in extruder flow rate and output. Surging can be associated with product defects caused by the instability of the flow rate through the extruder, variations in product exposure to extruder conditions such as temperature and pressure, etc.

Until recently, protein extrusion has generally been done in conjunction with the extrusion of one or more starches or functionally similar carbohydrates. For protein that is intended as an ingredient, increasing protein concentration has been reported to significantly increase extrudate density and breaking force. (Allen, K. E., Influence of Protein Level and Starch Type on an Extrusion-Expanded Whey Product, Int. J. Food Sci. Technol. (2007) 42(8): 953-960). Heating whey protein causes it to denature as a result of the protein structures unfolding, then undergoing aggregation. This results in protein-protein interactions that change the overall protein structure. Some of these changes are reversible (covalent) whereas other interactions are not reversible (non-covalent). Heating whey protein can change its structure and characteristics permanently, with denaturation generally occurring at around 70° C. for whey protein concentrate, for example (https://www.bulkpowders.co.uk/the-core/heating-stability-of-whey/).

Starches are generally nutritionally and functionally undesirable in protein bars. Nutritionally, starch may be undesirable for diabetics, those who are trying to adhere to a ketogenic diet, and those who simply want more protein and less carbohydrate in their diet. Functionally, starch can bind available moisture, impact moisture migration, encourage whey protein phase separation, influence gel formation and stability, and generally impact or participate in protein-carbohydrate interactions (Considine, T., A. Noisuwan, Y. Hemar, B. Wilkinson, J. Bronlund, and S. Kasapis (2011), Rheological investigations of the interactions between starch and milk proteins in model dairy systems: A review, Food Hydrocoll. 25:2008-2017; Shim, J. and S. J. Mulvaney (2001), Effect of heating temperature, pH concentration and starch/whey protein ratio on the viscoelastic properties of corn starch/whey protein mixed gels, J. Sci. Food Agric. 81:706-717). The addition of starch to protein to facilitate extrusion is therefore not desirable. Ideally, extruded protein intended for dietary use, for use as an ingredient in foods such as protein bars, etc., should be free of added starches. Preferably, it will comprise elevated levels of high-quality protein and few additional ingredients. However, extruding whey protein as either WPI or WPC can result in a product that is over-browned, dense, and nugget-like—a product that can be difficult to mill and may have undesirable flavor. It can also result in a product that has inconsistent color, texture, hardness, etc., due to extruder surging. It is therefore important to develop better methods for extruding whey protein to produce mill-able, puffed protein that can be used to produce powdered protein for use as an ingredient in a variety of products, including protein bars.

### SUMMARY OF THE INVENTION

The present invention provides a method for producing extruded protein products, the method comprising acidifying at least one protein to a pH of from less than 6 to the isoelectric point of the at least one protein, and processing the acidified protein using extrusion processing to produce an extrudate having a moisture level of less than or equal to about 35 percent. In various embodiments, the step of processing the protein mixture by extrusion is performed at from about 120 degrees to about 185 degrees Celsius and from about 500 to about 700 psi, to produce the extruded protein product.

In another aspect of the invention, the method for producing extruded protein products comprises admixing at least one protein with water and at least one acidulant to produce an acid/protein admixture with a pH of from less than 6 to the isoelectric point of the at least one protein, drying the admixture to produce an acidified protein product, and processing the acidified protein product using extrusion processing to produce an extruded protein product having a moisture level of less than or equal to about 35 percent. In various aspects, the step of processing the acidified protein product using extrusion processing is performed at from about 120 degrees to about 185 degrees Celsius and from about 500 to about 700 psi, to produce a low-moisture, high-protein, low-starch extruded protein product. In various aspects, the extruded protein product contains no appreciable levels of starch. In various aspects, the extruded protein product contains at least about 90 percent protein, at least about 95 percent whey protein, etc. In various aspects, the pH of the acidified protein product is from about 5.0 to about 5.8.

In various aspects of the invention, the extruded protein product is cut with an inline knife to reduce the size and provide smaller pieces of protein product, and those pieces are dried to produce crisps. Once dried and cooled, the resulting product can be milled to produce particles having a size of from about 75 to about 200 nm.

In various aspects of the invention, the at least one acid/acidulant is selected from the group of acids consisting of Citric, Malic, Fumaric, Hydrochloric, Lactic, Tartaric, Acetic, and combinations thereof.

In various aspects and/or embodiments of the invention, the protein is selected from the group consisting of whey protein isolate, whey protein concentrate, hydrolyzed whey protein, serum protein isolate, milk protein isolate, milk protein concentrate, micellar casein concentrate, calcium caseinate, other specialized caseinates, egg protein isolate, pea protein concentrate, pea protein isolate, chia protein concentrate, flax protein concentrate, and combinations thereof.

In various aspects of the invention, the protein is selected from the group consisting of whey protein isolate, whey protein concentrate, hydrolyzed whey protein, and combinations thereof.

In various aspects, the step of processing the hydrated protein mixture using extrusion is performed by using a twin-screw extruder.

The invention also provides a method for producing extruded whey protein products, the method comprising preparing a liquid blend consisting of at least one whey protein selected from the group consisting of whey protein isolate, whey protein concentrate, intact whey protein, and combinations thereof, and at least one acidulant to produce a pH of from about 5.0 to about 5.8 in the liquid blend, drying the liquid blend to produce an acidified whey protein product, and processing the hydrated acidified protein product using extrusion at from about 120 degrees to about 185 degrees Celsius and from about 500 to about 700 psi, to produce an extruded protein product having a moisture level of less than or equal to about 35 percent.

The invention, in some aspects also provides a method for producing extruded protein products, the method comprising admixing at least one protein with at least one acidified protein to produce a pH of from less than 6 to the isoelectric point of the at least one protein and processing the admixture using extrusion processing to produce a product which can be formed into a crisp by drying to a moisture level of from about 1 to about 12 percent. In various aspects, the pH is from about 5.0 to about 5.8. In various aspects, the at least one protein is at least one whey protein.

In various aspects, the method of the invention can comprise the steps of rehydrating a dried acidified protein powder and processing the hydrated protein powder using extrusion at, for example, from about 120 degrees to about 185 degrees Celsius and from about 500 to about 700 psi, to produce an extruded protein product. In various aspects the extruded protein product has moisture level of less than or equal to about 35 percent. In various aspects, a dried crisp made from the extruded protein product will dried to produce a moisture content of from about 1 to about 12 percent.

The invention also relates to products made by the method of the invention. Also, since the products made by the method of the invention are mill-able, and can readily be milled to produce protein powders having outstanding functionality, the invention in its various aspects also relates to protein powders produced by the method of the invention.

### BRIEF DESCRIPTION OF THE DRAWINGS

FIG. 1 is a photograph of two extrusion products made using a twin-screw extruder by hydrating the protein mixture to a moisture level of less than or equal to about 35 percent, and processing the hydrated protein mixture using extrusion at from about 120 degrees to about 185 degrees Celsius and from about 500 to about 700 psi, to produce an extruded protein product. The product on the left was made using WPI, while the product on the right was made by combining WPI with pre-acidified WPI to produce a protein/pre-acidified protein mixture having a pH of 5.3.

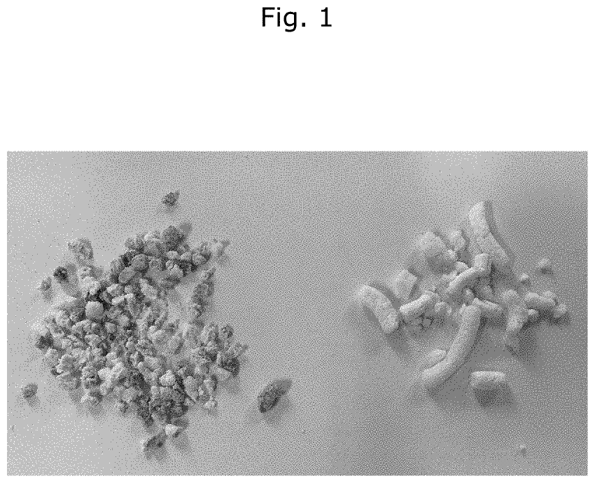

FIG. 2 and FIG. 3 are photographs illustrating the difference between extruded whey protein puffs produced at pH 6.0 under normal extruder output (FIG. 2) and extruded whey protein puffs produced at the same pH during extruder surging (FIG. 3).

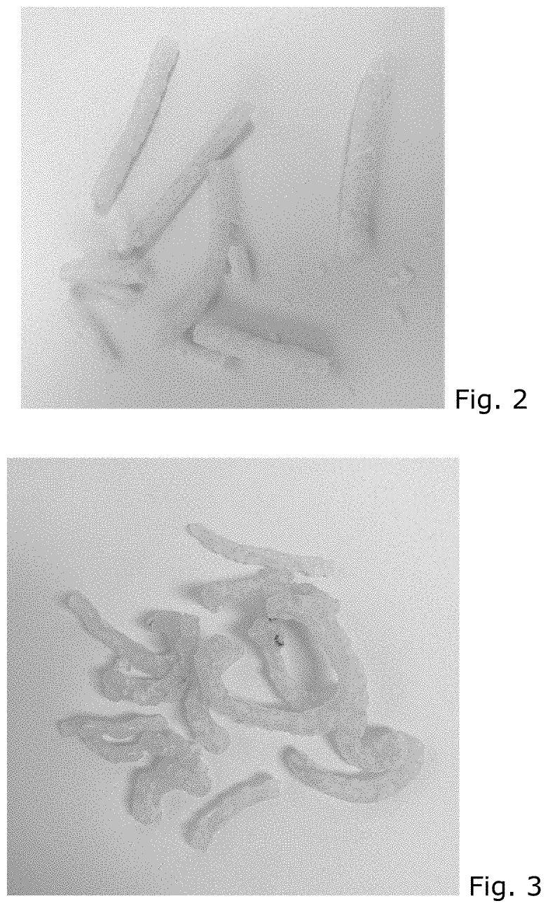

FIG. 4 and FIG. 5 are photographs illustrating the difference between similarly-processed extruded whey protein puffs, but using pH 5.5 for the starting mix for the puffs in FIG. 4 and pH 6.5 for the starting mix for the puffs in FIG. 5.

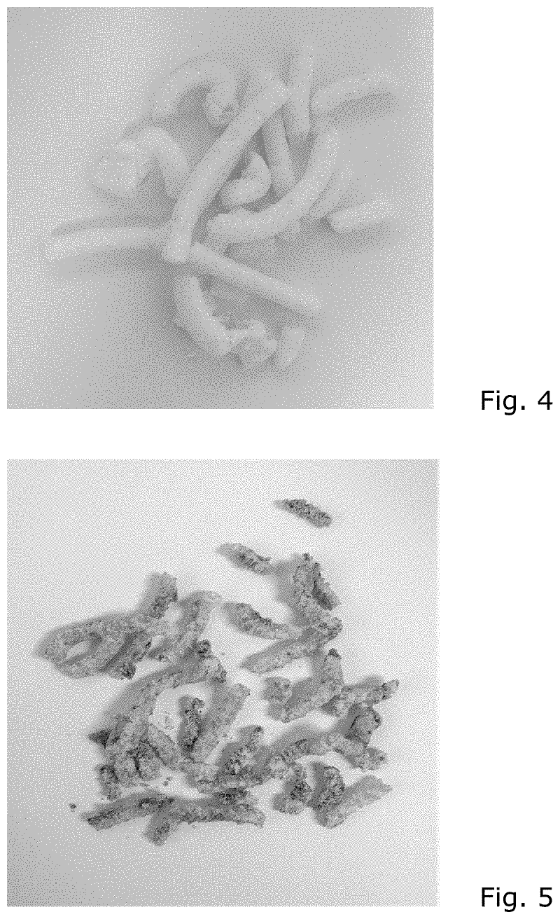

FIG. 6 and FIG. 7 are photographs illustrating the difference between pea protein products extruded under similar conditions, with FIG. 6 representing the untreated product (control) and FIG. 7 representing a product processed according to the method of the invention.

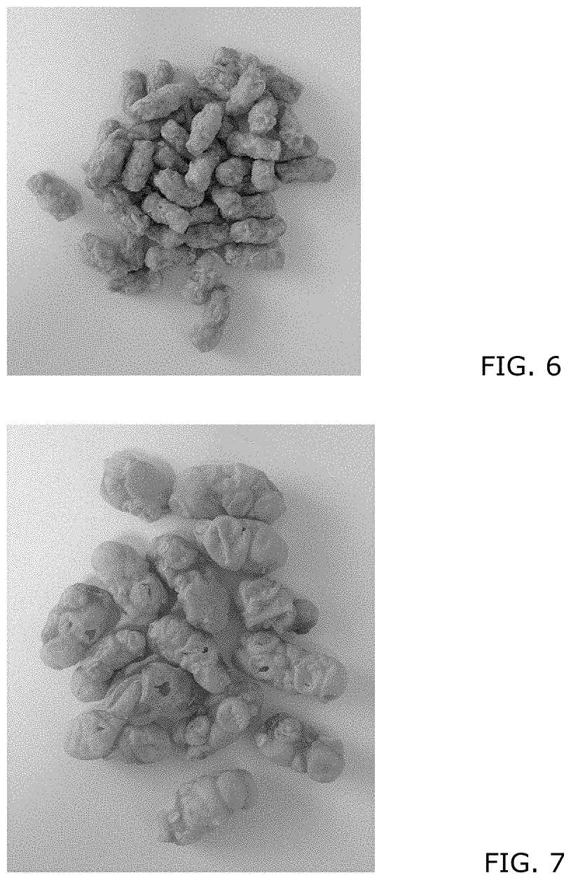

### DETAILED DESCRIPTION

The inventors have developed a method for making extruded, puffed protein products (e.g., puffed whey protein products, puffed pea protein products), which may also be referred to as “crisps,” that are easily milled and have excellent properties-both as crisps and as powders—for use as ingredients in products such as nutritional bars, which are shelf-stable for extended periods of time. The invention provides a method for producing extruded protein products, wherein the extruded protein products are high-protein, low-starch, and low-moisture products. The method comprises acidifying at least one protein with at least one acid to provide an acidified protein in the pH range of from about 6 as an upper limit to just above the isoelectric point of the at least one protein as a lower limit. The pH is targeted in a range that is acidic, but higher than the isoelectric point of the protein, and the protein/acid admixture is processed using extrusion processing to produce an extruded protein product generally having a moisture content of about 35% or less (e.g., less than or equal to 35%). The innovative method allows the protein to increase in structure and viscosity through gelation, while still providing protein that does not clog the die or impede throughput. This can decrease or eliminate extruder surge, and provide products that are extruded at a significantly more consistent rate. The puffed form can readily be ground, milled, or otherwise reduced in size to produce protein powder that can be used to reduce hardening in protein bars when incorporated as ingredient in those bars. The product produced by the method of the invention is a milled high-protein crisp, not to be confused with a product such as texturized vegetable protein (TVP). Crisps of the invention are low-moisture, high-protein products that are expanded without relying on the use of starch to produce the expansion., and are referred to herein as “low-starch” products because they will comprise no more than 5% starch (i.e., less than or equal to about 5% starch), and preferably no appreciable levels of starch, at all.

The invention provides a method for producing extruded protein products, and is especially useful for producing extruded whey protein products. Acidification of the protein can be achieved by various means known to those of skill in the art, such as, for example, combining at least one protein with at least one pre-acidified protein to produce a protein/pre-acidified protein mixture having a pH of from about 6.0 to about the isolectric pH of the at least one protein, from about 5.0 to about 5.8, etc. The protein thus acidified is processed by extrusion under conditions known to those of skill in the art to be appropriate for the selected protein(s). For example, for whey protein extrusion at from about 120 degrees to about 185 degrees Celsius and from about 500 to about 700 psi provides good results. In various aspects of the method, the pH of the protein/pre-acidified protein mixture is from about 5.0 to about 6.0, from about 5.0 to about 5.9, from about 5.0 to about 5.8, from the isoelectric point of the at least one protein to about 6.0, from the isoelectric point of the at least one protein to about 5.9, from the isoelectric point of the at least one protein to about 5.8, from 5.0 to about 5.5, from the isoelectric point of the at least one protein to about 5.5, etc. It will be understood by those of skill in the art, given the disclosure herein, that selection of a pH in a range that falls slightly above the isoelectric point of the at least one protein is desirable for use in the method. The pH range should be also understood to encompass sub-ranges thereof.

In another aspect of the invention, the method for producing extruded whey protein products comprises admixing with water a whey product selected from the group consisting of whey protein isolate, whey protein concentrate, intact whey protein, and combinations thereof, and an acidulant to produce an admixture with a pH of from about 5.0 to about 5.8, drying the admixture to produce an acidified whey protein product, and processing the hydrated protein mixture using extrusion at from about 120 degrees to about 185 degrees Celsius and from about 500 to about 700 psi, to produce an extruded protein product. In various aspects, the extruded protein product has a moisture content of less than about 35 percent.

The method can also comprise the steps of reconditioning a dried acidified protein powder, and processing the reconditioned protein powder using extrusion at from about 120 degrees to about 185 degrees Celsius and from about 500 to about 700 psi, to produce an extruded protein product.

In various aspects of the invention, the extruded protein product is cut with a knife such as, for example, an inline knife (i.e., inline cutting system) to reduce the size and provide smaller pieces of protein product. Those pieces can then be dried to produce protein puffs. Once dried and cooled, the protein puffs can be milled to produce power having a particle size of less than about 200 nm, for example. Suitable milling/grinding equipment is commercially available. One option for milling extruded protein puffs is the Comitrol® 1700 Processor. Generally, it is advisable to cut the protein puffs to a length of about 2.5 inches or less before drying in order to produce puffs of suitable size for such a milling device.

Under the same extrusion conditions, WPI will generally gel, burn, and clog up in the extruder, or in the best case scenario, produce a product that consists of browned hardened nuggets, while the whey protein/acidified whey protein combination of the method of the invention will smoothly process and produce an extruded product that can readily be dried to produce a whey protein puff having a lighter color and more pleasant texture and flavor that is more reminiscent of the whey crisp products that can be produced using a combination of whey and carbohydrate. It should be clear to those of skill in the art that using starch or other carbohydrates in high protein products such as bars can be undesirable, particularly in regard to nutritional needs and protein/carbohydrate interactions. The present method allows a formulator to produce a protein puff that is readily mill-able to produce a protein powder that has the improved properties that can be provided by extrusion processing. Small amounts of acidification are occasionally used to improve viscosity in extruded products, however in protein applications, acidification will encourage even more gelling and hardening. Thus, acidifying high-protein products can increase the already high risk of gelation, clogging the extruder, and browning. Because of this, high levels of acidity are typically seen as something to avoid in high protein extrusion, with some choosing to add alkali treatments to improve extrusion in high protein (75-95%) blends (see WO2016/054657, Erie Foods Intl.). However, the inventors have discovered that when tightly controlled, the molecular interaction of the protein molecules, gelling and hardening induced by acid can encourage useful structural changes to the resulting extruded crisp itself. Starch often performs a roll in gel/gelatinized starch matrices in crisp recipes, and the inventors have discovered that encouraging some amount of protein gelling by acidification of the protein can actually reduce the need for starch.

Although acidification of WPI chemically generally promotes more gelling, this change in rheological properties actually helps the whey protein/acidified whey protein combination move through the extruder without gelling to a level that would clog the extruder and stop the product flow. Promoting a consistent flow rate and pressure allows the product to puff, which can be important for proper drying and eventual milling. The method of the invention provides a means by which protein can be extruded without requiring the addition of starch to facilitate extrusion. The method therefore can be practiced without the addition of starch to the protein mixture, and products made by the method can comprise little to no starch. The method also enables those of skill in the art to extrude whey protein, a protein that has traditionally proven to be more challenging for extrusion processing and crisp production, providing whey protein products made at least about 90 percent whey protein, at least about 95 percent whey protein, and/or exclusively whey protein.

“Acidified whey protein,” or “pre-acidified whey protein,” as used herein, is a whey protein product such as that described in U.S. Patent Number 8,637,102 (Petersen, B., et al.). It can be produced by combining whey protein (e.g., whey protein isolate) with a sufficient amount of acid in solution to give a solution with an acidic pH (i.e., below pH 6). The acidified protein is then dried to form an acidified protein powder. Acidified whey protein is commercially available from Glanbia Nutritionals, Inc. (Monroe, Wis.) as Bevwise® A-102W.

Starting material(s) for use in the method of the invention can include, for example, whey protein isolate, whey protein concentrate, serum protein isolate, milk protein isolate, milk protein concentrate, micellar casein concentrate, calcium caseinate, other specialized caseinates, egg protein isolate, pea protein concentrate, pea protein isolate, chia protein concentrate, flax protein concentrate, and combinations thereof. The method is especially useful, however, for producing mill-able puffed whey protein, as it overcomes problems that have been associated especially with whey protein extrusion, and particularly for extrusion of whey protein under lower moisture (i.e., 35% or less) conditions.

“Extrusion,” as used herein, generally refers to the process of processing the protein mixture using either a single-screw or twin-screw extruder (with the twin-screw extruder being preferred). Both types of machines are well known to those of skill in the art, and are readily available from a variety of equipment manufacturers. Briefly, a twin-screw extruder is a machine having two relatively identical screws that are mounted on shafts and rotate in the same direction in a fixed, closed, housing referred to as a “barrel.” Suitable extruders for use in the method of the invention are available from a variety of manufacturers such as, for example, the Buhler Poly-Twin™ (Bühler AG, Uzwil, Switzerland), a line of extruders from Entek (Lebanon, Oreg. USA), MPX30, MPX40, MPX50, MPX65, and MPX80 extruders from Baker Perkins (Baker Perkins Limited, Peterborough UK), etc. Conditions for extrusion, known to those of skill in the art, are disclosed, for example, in WO2016/054657 (Erie Foods International, Inc.). However, that publication discloses the extrusion of whey protein, acid casein, and alkali, rather than acidified whey protein, the pH produced by that method as compared to the present method being significantly different. The present method also provides a means by which all the protein can be whey protein, which can be significantly more desirable in many product formulations.

Whey proteins have been extruded for many years under high (>35, up to 90%) moisture levels, in a process widely known as functionalization, to create gelatinized products usable as meat replacers. Milk protein concentrate, which is less prone to gelation and has better pasting properties, being a combination of casein and whey in a ratio of 4:1 casein/whey, has been successfully extruded under low-moisture conditions. However, the inventors are unaware of similar results being produced using isolated whey protein in the form of whey protein isolate or whey protein concentrate. Generally, it has been thought that increasing protein concentrate in an extruded product significantly increases the density and breaking force of the extruded product, so extruding products comprising all, or substantially all, whey protein can be challenging and can result in dense, brittle, products that are not amenable to milling to produce protein powders (Allen, K. E., et al., Influence of Protein Level and Starch Type on an Extrusion-Expanded Whey Product, Int. J. Food Sci. Technol. (2007) 42(8): 953-960).

Brnčić et al., (Influence of Whey Protein Addition and Feed Moisture Content on Chosen Physicochemical Properties of Directly Expanded Corn Extrudates, Food and Bioprocess Technology, October 2011, 4(7):1296-1306) demonstrated that whey protein can be used in traditional extruded products, but increasing concentrations can impact the product, with increasing protein concentrations impacting both the water solubility index and water absorption index. These differences were particularly pronounced in acidic conditions. Day and Swanson (Functionality of Protein-Fortified Extrudates, Comprehensive Reviews in Food Science and Food Safety, September 2013 Vol. 12(5), p. 546-564) noted that “WPC . . . in excess of 20% resulted in decreased expansion and low sensory scores.” Others have disclosed undesirable absorption characteristics, textural characteristics, and color in whey protein crisps having high levels of whey protein. noting that the changes were most pronounced in whey protein crisps with low pH. Most importantly, gelling and cross-linkage of whey protein typically made products more difficult to extrude at lower pH. Progress has been made to increase the protein content in high protein crisps (e.g., 90% protein has been disclosed in WO2016/054657). However, that method was performed used an alkalizing agent to increase the pH.

To address the problem of hardening in the extruder, some have used low temperature supercritical carbon dioxide assisted production for extruded whey having a range of from about 50 to about 75 percent whey protein. Obviously, measures such as these can significantly add to the cost of production, which is not the case with the present invention.

The previous observations reported by others in the field has made it counterintuitive to suggest that the solution to processing of extruded whey protein products having high levels of whey protein (e.g., at least about 80%, by weight) would be to acidify the product. One would expect a decrease in water absorption, higher viscosity earlier in the barrel, and significant cross-linkage and gel formation at the temperatures and pressures used. However, the inventors have discovered that these developments can actually be manipulated to perform a useful purpose under the controlled conditions which are disclosed herein.

The invention also provides protein products made by the method of the invention. Protein products made by the method of the invention can also include protein powders having excellent color, flavor, wettability, etc., which make the protein powder an excellent ingredient for use in nutritional bar formulations.

While a method and/or composition may be described herein as “comprising” a series of steps, it should be understood that such a method can also more narrowly “consist of” the recited steps, and such a method can additionally be described as “consisting essentially of” the recited series of steps.

The invention can be further described by means of the following non-limiting examples.

### EXAMPLES

### Production of a Mill-Able Extruded Puffed Whey Protein

WPI (Provon® 190, Glanbia Nutritionals, Monroe, Wis. USA) powder and an acidified WPI (Bevwise® A-102W, Glanbia Nutritionals) powder were admixed at a ratio that should result an estimated pH 5.3 for the admixture (i.e., 17% Bevwise® A-102W, 83% Provon® 190). The dry mixture was then fed into the extruder with enough water to achieve an approximate 27% moisture content. The addition of water was the only “pretreatment” performed on the admixture. The mixture was then fed into a twin-screw extruder.

Temperature was adjusted to produce multiple runs for comparison, and observations indicated that lower temperatures yielded a more uniform “puffed” product, but it was more prone to surging and inconsistency in the result. Higher temperatures yielded slightly less puffing and product cohesion, which was selected as the target result. Product runs were therefore conducted at higher temperatures within the range of 120 degrees to about 185 degrees Celsius. As product exited the extruder, it was cut with a rotating knife, then fed into an oven to be dried.

### Production of a Mill-Able Extruded Puffed Pea Protein

Extrusion of pea protein was performed in substantially the same manner as that described above for whey protein. Citric acid was blended into pea protein concentrate (“treated”) and the mix was extruded under typical extrusion conditions. The protein extrudate was more easily extruded, more expanded, and more porous than that produced with untreated protein.

What is claimed is:

1. A method for producing a high-protein, low moisture extruded protein product, the method comprising
(a) acidifying at least one protein to provide an acidified protein having a pH of from below 6.0 to above the isoelectric point of the at least one protein;
(b) processing the acidified protein by extrusion processing to produce an extrudate having a moisture content of about 35 percent or less; and
(c) drying the extrudate to produce a mill-able extruded protein product, wherein the extruded protein product is a high-protein, low-starch product having a moisture content of from about 1% to about 12%.

2. The method of claim 1 wherein the pH of the acidified protein is from about 5.0 to about 5.8.

3. The method of claim 1 further comprising the step of cutting the extruded protein.

4. The method of claim 1 further comprising the step of milling the extruded protein product to produce a protein powder with particle of less than or equal to about 200 nm.

5. The method of claim 1 wherein the protein is selected from the group consisting of whey protein isolate, whey protein concentrate, serum protein isolate, milk protein isolate, milk protein concentrate, micellar casein concentrate, calcium caseinate, other specialized caseinates, egg protein isolate, collagen concentrate, pea protein concentrate, pea protein isolate, chia protein concentrate, flax protein concentrate, soy protein concentrate, wheat protein concentrate, rice protein concentrate, and combinations thereof.

6. The method of claim 1 wherein the protein is selected from the group consisting of whey protein isolate, whey protein concentrate, hydrolyzed whey protein, and combinations thereof.

7. The method of claim 1 wherein the step of processing the hydrated protein mixture using extrusion performed by using a twin-screw extruder.

8. The method of claim 1 wherein the protein mixture is made without added starch.

9. A method for producing extruded high-protein, low moisture whey protein products, the method comprising
(a) admixing with water a whey product selected from the group consisting of whey protein isolate, whey protein concentrate, intact whey protein, and combinations thereof, and at least one acidulant to produce an admixture having a pH of from about 5.0 to about 5.8;
(b) drying the admixture to produce an acidified whey protein product; and
(c) processing the acidified whey protein product using extrusion at from about 120 degrees to about 185 degrees Celsius and from about 500 to about 700 psi, to produce an extruded protein product having a moisture content of about 35 percent or less; and

10. The method of claim 9 further comprising a step (d) drying the extruded protein product to moisture level from about 1% to about 12%.

11. A method for producing extruded protein products comprising the steps of
(a) admixing at least one protein powder with at least one acidified protein powder to provide at admixture having a pH having an upper limit of pH 6.0 and a lower limit that is selected to be slightly above the isoelectric pH of the at least one protein; and
(b) processing the hydrated protein powder using extrusion under conditions selected for the protein, wherein the extrusion process produces an extruded protein product having a moisture content of less than or equal to about 35%.

12. The method of claim 11 further comprising the step (c) of drying the extruded protein product to provide a moisture level of from about 1 percent to about 11 percent, thereby producing a protein crisp.

13. The method of claim 12 further comprising the step (d) of milling the protein crisp to produce a high-protein, low-starch protein powder.
